(19) United States
(12) Patent Application Publication
(10) Pub. No.: US 2016/0133174 A1
(43) Pub. Date: May 12, 2016

(54) DATA PROCESSING DEVICE AND DISPLAY DEVICE HAVING THE SAME

(71) Applicant: SAMSUNG DISPLAY CO., LTD., Yongin-City (KR)

(72) Inventors: Geun-Young JEONG, Busan (KR); Ji-Yeon YANG, Hwaseong-si (KR)

(21) Appl. No.: 14/751,764

(22) Filed: Jun. 26, 2015

(30) Foreign Application Priority Data
Nov. 11, 2014 (KR) 10-2014-0155793

(51) Int. Cl. G09G 3/20; G09G 5/06

(52) U.S. Cl. CPC G09G 3/2003; G09G 5/06; G09G 2300/0452; G09G 2320/0276; G09G 2320/0233; G09G 2320/0242; G09G 2320/0673

(57) ABSTRACT

A data processing device includes an input gamma processor, a renderer, and an output gamma processor. The input gamma processor generates first image data by linearizing input image data based on a variable gamma lookup table which changes based on a predetermined gamma weight. The renderer renders the first image data to generate second image data. The output gamma processor generates output image data based on non-linearizing the second image data based on an output gamma lookup table. The output gamma lookup table is calculated based on a reverse gamma function of the variable gamma lookup table.

### CROSS-REFERENCE TO RELATED APPLICATION

Korean Patent Application No. 10-2014-0155793, filed on Nov. 11, 2014, and entitled, “Data Processing Device and Display Device Having The Same,” is incorporated by reference herein in its entirety.

### BACKGROUND

1. Field

One or more embodiments described herein relate to a data processing device and a display device having a data processing device.

2. Description of the Related Art

A variety of flat panel displays have been developed. Examples include liquid crystal displays, field emission displays, plasma display panels, and organic light emitting display. The displays are lighter and thinner compared to cathode-ray tube displays and therefore have had much commercial success. Additionally, organic light emitting displays have a wider viewing angle and faster response speed and is thinner and consumes less power than many other types of flat panel displays.

An organic light emitting display may include sub pixels that emit red, green, and blue light. The light is mixed to form a range of colors. One type of organic light emitting display has a pentile-type of pixel layout, in which red and blue sub pixels are alternately arranged in the same row and green color sub pixels are arranged adjacent to the red and blue sub pixels.

### SUMMARY

In accordance with one or more embodiments, a data processing device includes an input gamma processor to generate first image data, the input gamma processor to linearize input image data based on a variable gamma lookup table, the variable gamma lookup table to change based on a predetermined gamma weight; a renderer to render the first image data to generate second image data; and an output gamma processor to generate output image data based on non-linearizing the second image data based on an output gamma lookup table, the output gamma lookup table to be calculated based on a reverse gamma function of the variable gamma lookup table.

The input gamma processor may include a reference gamma lookup table to store reference luminance data according to a predetermined reference gamma value; and a compensation gamma lookup table to store compensation luminance data to be used to compensate the reference luminance data. The compensation gamma lookup table may store compensation luminance data, and the compensation luminance data is based on a difference between the reference luminance data corresponding to the reference gamma value and maximum luminance data corresponding to a predetermined maximum compensation gamma value. The variable gamma lookup table may store variable luminance data generated based on adding a multiplication value of the compensation luminance data and the gamma weight to the reference luminance data.

The input gamma processor may include a plurality of sub gamma lookup tables having different gamma values. The input gamma processor may select one of the sub gamma lookup tables as the variable gamma lookup table based on the gamma weight.

The data processor may be in or coupled to a display device having a pentile-shape structure, and the pentile-shape structure has a pixel layout which may include a red color sub pixel, a first green color sub pixel, a blue color sub pixel, and a second green color sub pixel.

The renderer may render the first image data based on the pixel layout using a rendering filter. The output gamma lookup table may store grayscale data calculated based on the reverse gamma function of the variable gamma lookup table.

In accordance with one or more other embodiments, display device includes a display panel having a pentile-shape structure, the pentile-shape structuring having a pixel layout which includes a red color sub pixel, a first green color sub pixel, a blue color sub pixel, and a second green color sub pixel; a variable gamma lookup table to be changed based on a predetermined gamma weight; a data processor to generate output image data, the data processor to linearize input image data according to the variable gamma lookup table and to render the linearized input image data according to the pixel layout; a data driver to provide a data signal to the display panel, the data signal corresponding to the output image data; a scan driver to provide a scan signal to the display panel; and a timing controller to generate control signals to control the data driver and the scan driver.

The data processor may include an input gamma processor to generate first image data, the input gamma processor to linearize the input image data based on the variable gamma lookup table, the variable gamma lookup table to change based on the gamma weight; a renderer to render the first image data to generate second image data; and an output gamma processor to generate image data, the output gamma processor to non-linearize the second image data based on an output gamma lookup table, the output gamma lookup table to be calculated based on a reverse gamma function of the variable gamma lookup table.

The input gamma processor may include a reference gamma lookup table to store reference luminance data according to a predetermined reference gamma value; and a compensation gamma lookup table to store compensation luminance data that compensates the reference luminance data.

The compensation gamma lookup table may store compensation luminance data, and the compensation luminance data may be based on a difference between the reference luminance data corresponding to the reference gamma value and a maximum luminance data corresponding to a predetermined maximum compensation gamma value.

The variable gamma lookup table may store variable luminance data, the variable luminance data to be generated based on adding a multiplication value of the compensation luminance data and the gamma weight to the reference luminance data. The input gamma processor may include a plurality of sub gamma lookup tables having different gamma values. The input gamma processor may select one of the sub gamma lookup tables as the variable gamma lookup table based on the gamma weight. The renderer may render the first image data based on the pixel layout using a rendering filter.

The output gamma lookup table may store grayscale data calculated based on the reverse gamma function of the variable gamma lookup table. The timing controller maybe coupled to the data processor. The timing controller may include the data processor.

### BRIEF DESCRIPTION OF THE DRAWINGS

Features will become apparent to those of skill in the art by describing in detail exemplary embodiments with reference to the attached drawings in which:

FIG. 1 illustrates an embodiment of a data processing device;

FIG. 2 illustrates an embodiment of an input gamma processing unit;

FIG. 3 illustrates an example of a variable gamma lookup table;

FIG. 4 illustrates another embodiment of an input gamma processing unit;

FIG. 5 illustrates another example of a variable gamma lookup table;

FIGS. 6 and 7 illustrate examples operations of a rendering unit;

FIG. 8 illustrates an embodiment of a display device;

FIG. 9 illustrates an embodiment of an electronic device; and

FIG. 10 illustrates an embodiment of a smart phone.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout. One or more embodiments may be combined to form additional embodiments.

FIG. 1 illustrates an embodiment of a data processing device 100 which includes an input gamma processing unit 120, a rendering unit 140, and an output gamma processing unit 160. The data processing device 100 converts input image data so that it may be applied to a display panel having a pentile-shape structure of pixels. In one embodiment, the pentile-shape structure corresponds to a pixel layout having a red color sub pixel, a first green color sub pixel, a blue color sub pixel, and a second green color sub pixel.

The input gamma processing unit 120 generates and outputs first image data 1ST ID, for example, by linearizing input image data INPUT ID based on a variable gamma lookup table that is changed based on a predetermined gamma weight GW. The input image data INPUT ID may be provided, for example, from an external system, and may include red color grayscale data, green color grayscale data, and blue color grayscale data.

The input gamma processing unit 120 may generate the first image data 1ST ID, for example, by linearizing the input image data INPUT ID that has a non-linear property based on the variable gamma lookup table. The variable gamma lookup table may store variable luminance data that linearize the input image data INPUT ID. The variable gamma lookup table may be changed based on the predetermined gamma weight GW. The gamma weight GW may be value that controls a degree of compensation for compensating gamma distortion of the display panel having the pentile-shape structure.

In one embodiment, the gamma weight GW may be determined based on a property of the display panel. For example, the gamma weight GW may be determined based on a loading effect because a gamma curve may be distorted by the loading effect. In one example embodiment, the gamma weight GW may increase when a gamma value of the gamma curve increases because of the loading effect. The gamma weight GW may decrease when the gamma value of the gamma curve increases because of the loading effect. The gamma weight GW may have values which lie in a predetermined range, e.g. higher than 0 and lower than 1.

The input gamma processing unit 120 may include a reference gamma lookup table and a compensation gamma lookup table. The reference gamma lookup table may store luminance data corresponding to a reference gamma value. For example, the reference gamma value may be 2.2. The compensation gamma lookup table may store compensation luminance data that compensates the reference luminance data. The compensation gamma lookup table may store compensation luminance data, which may be based a difference between the reference luminance data corresponding to the reference gamma value and maximum luminance data corresponding to a predetermined maximum compensation gamma value. For example, the maximum compensation gamma value may be 3.0. The variable gamma lookup table may store the variable luminance data, which may be generated, for example, by adding a multiplication value of the compensation luminance data and the gamma weight GW to the reference luminance data.

In another example embodiment, the input gamma processing unit 120 may include a plurality of sub gamma lookup tables having different gamma values. For example, the input gamma processing unit 120 may store the sub gamma lookup tables having the gamma values higher than the reference gamma value and lower than the maximum compensation gamma value. The input gamma processing unit 120 may select one of the sub gamma lookup tables as the variable gamma lookup table based on the gamma weight GW. The first image data 1ST ID may be generated, for example, by linearizing the input image data INPUT ID based on the variable gamma lookup table.

The rendering unit 140 may generate second image data 2ND ID by rendering the first image data 1ST ID and may output the second image data 2ND ID. The rendering unit 140 may generate the second image data 2ND ID, for example, by rendering the first image data 1ST ID based on the pixel layout using a rendering filter. For example, the rendering unit 140 may generate the second image data 2ND ID that includes red color variable luminance data, first green color variable luminance data, blue color variable luminance data, and second green color variable luminance data by rendering the first image data 1ST ID that includes red color variable luminance data, green color variable luminance data, and blue color variable luminance data. The rendering unit 140 may render the first image data 1ST ID based on the pixel layout using a predetermined rendering filter, e.g., a 3×3 or a 3×1 rendering filter.

The output gamma processing unit 160 generates output image data OUTPUT ID, for example, by non-linearizing the second image data 2ND ID based on an output gamma lookup table calculated based on a reverse gamma function of the variable gamma lookup table. The output gamma processing unit 160 then outputs the output image data OUTPUT ID. The output gamma lookup table, calculated based on the reverse gamma function of the variable gamma lookup table, may be changed based on the gamma weight GW, because the variable gamma lookup table is changed by the gamma weight GW. For example, the output gamma lookup table may be calculated based on the reverse gamma function having a 2.4 gamma value when the variable gamma lookup table is formed based on the gamma function having the 2.4 gamma value.

The output gamma lookup table may store grayscale data calculated using the reverse gamma function of the variable gamma lookup table. For example, the output gamma processing unit 160 may generate the output image data OUTPUT ID (that includes the red color output grayscale data, the first green color output grayscale data, the blue color output grayscale data, and the second green color output grayscale data) by non-linearizing the second image data 2ND ID (that includes the red color variable luminance data, the first green color variable luminance data, the blue color variable luminance data, and the second green color variable luminance data). The red color output grayscale data, the first green color output grayscale data, the blue color output grayscale data, and the second green color output grayscale data may be grayscale data corresponding to the red color sub pixel, the first green color sub pixel, the blue color sub pixel, and the second green color sub pixel of the display panel having the pentile-shape structure.

The data processing device 100 may have a different structure in another embodiment. For example, the data processing device 100 may include an edge processing unit for processing edge data and a dithering unit for performing a dithering function.

As described above, the data processing device 100 of FIG. 1 may generate the first image data 1ST ID by linearizing the input image data INPUT ID based on the variable gamma lookup table which is changed based on the gamma weight GW, may generate the second data 2ND ID by rendering the first image data 1ST ID, and may generate the output image data OUTPUT ID by non-linearizing the second image data 2ND ID based on the output gamma lookup table. The gamma weight GW may be a value that controls the degree of compensation for compensating gamma distortion of the display panel having the pentile-shape structure. The gamma weight GW may be determined, for example by one or more properties of the display panel. The data processing device 100 may compensate the gamma distortion in the display panel having the pentile-shape structure, by including the variable gamma lookup table having a gamma value changed based on the gamma weight GW. Thus, image quality of the display panel may be improved.

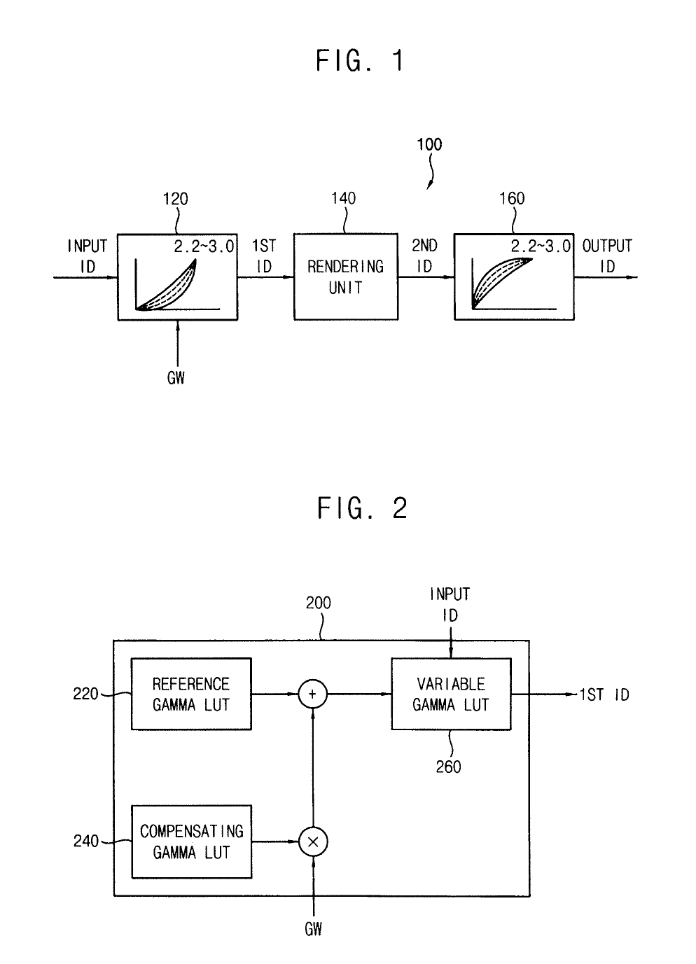

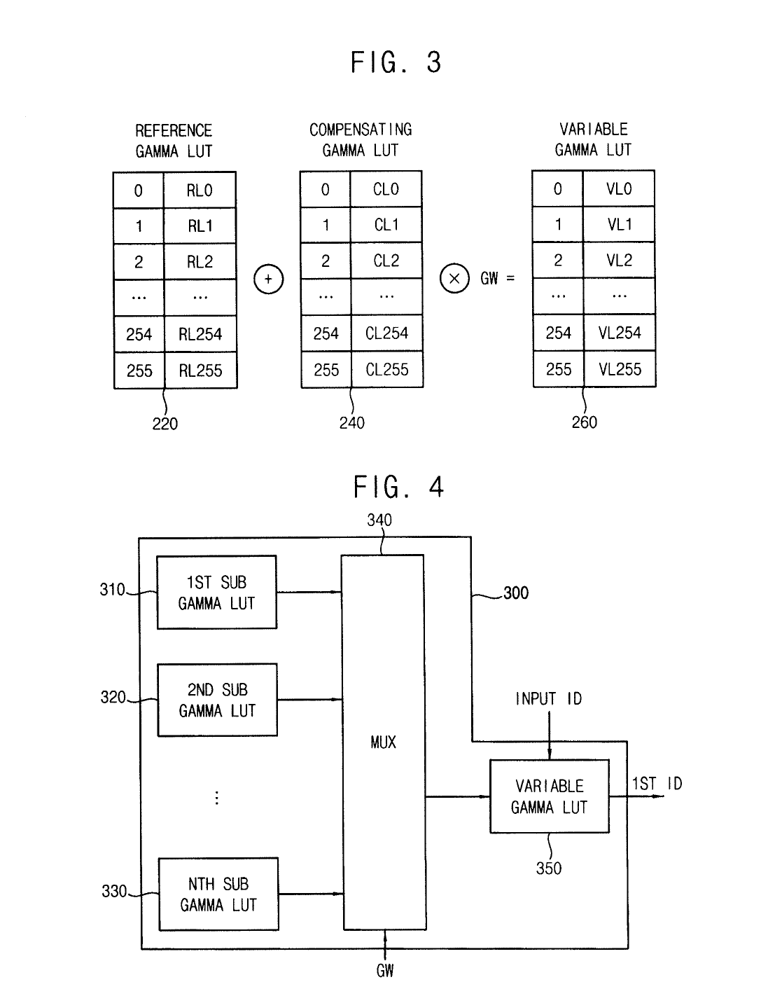

FIG. 2 illustrates an embodiment of n input gamma processing unit 200, which, for example, may be included in the data processing device of FIG. 1. FIG. 3 illustrates an example of a variable gamma lookup table in the input gamma processing unit 200.

Referring to FIGS. 2 and 3, the input gamma processing unit 200 includes a reference gamma lookup table 220 and a compensation gamma lookup table 240. The reference gamma lookup table 220 stores reference luminance data RL0 thorough RL255 according to a predetermined reference gamma value. For example, the reference gamma lookup table may store the reference luminance data RL0 through RL255 according to a 2.2 gamma value. The compensation gamma lookup table 240 stores compensation luminance data CL0 through CL255 that compensates the reference luminance data RL0 through RL255.

The compensation gamma lookup table 240 may store a difference between the reference luminance data RL0 through RL 255 and maximum luminance data corresponding to a predetermined maximum compensation gamma value as the compensation luminance data CL0 through CL255. For example, the maximum compensation gamma value may be 3.0, and the compensation gamma lookup table 240 may store the difference between the reference luminance data RL0 through RL255 corresponding to the 2.2 gamma value and the maximum luminance data corresponding to the 3.0 gamma value as the compensation luminance data CL0 through CL255.

The variable gamma lookup table 260 stores variable luminance data VL0 through VL255 generated, for example, by adding a multiplication value of the compensation luminance data CL0 through CL255 and the gamma weight GW to the reference luminance data RL0 through RL255. The gamma weight GW may be a value that controls the degree of compensation for compensating gamma distortion of the display panel having the pentile-shape structure.

The gamma weight GW may be determined based on one or more properties of the display panel. For example, the gamma weight GW may be determined based on a loading effect, because a gamma curve of the display panel may be distorted by the loading effect. In one example embodiment, the gamma weight GW may increase when the gamma curve increases because of the loading effect. The gamma weight GW may decrease when the gamma curve increases because of the loading effect. The gamma weight GW have values that lie within a predetermined range, e.g., higher than 0 and lower than 1.

In the aforementioned example, the input gamma processing unit 200 may linearize the input image data INPUT ID based on the variable lookup table 260, that stores the variable luminance data corresponding to the 2.2 gamma value through the 3.0 gamma value. The input gamma processing unit 200 may generate the first image data 1ST ID by linearizing the input image data INPUT ID based on the variable gamma lookup table 260.

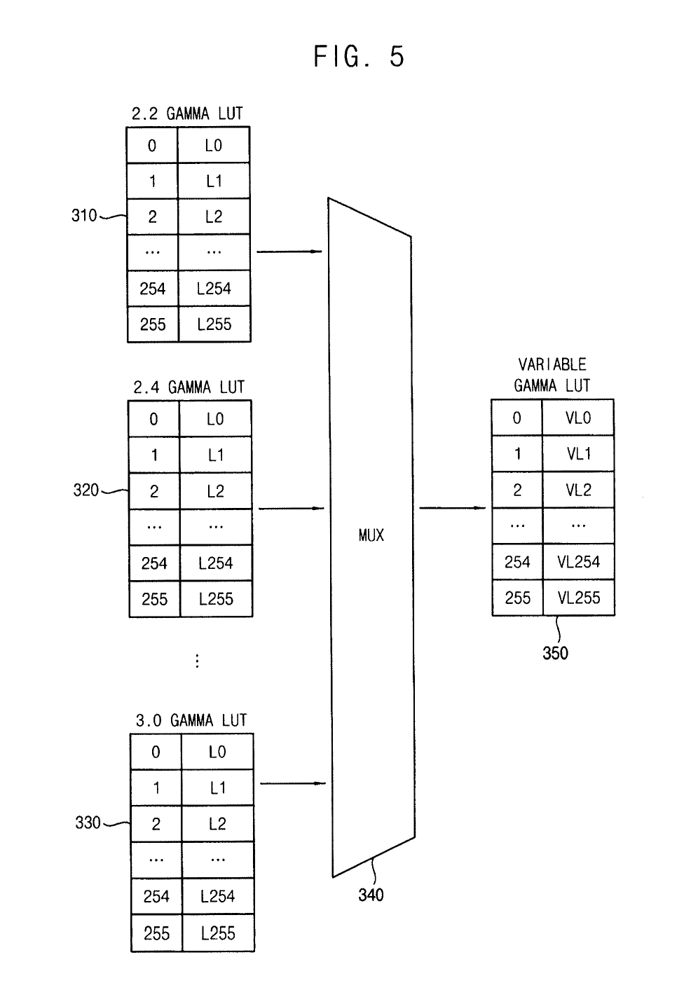

FIG. 4 illustrates another embodiment of an input gamma processing unit 300, which, for example, may be included in the data processing device of FIG. 1. FIG. 5 illustrates a variable gamma lookup table in the input gamma processing unit 300.

Referring to FIGS. 4 and 5, an input gamma processing unit 300 may include a plurality of sub gamma lookup tables 310, 320, and 330 having different gamma values and a multiplexer 340. The input gamma processing unit 300 includes a first sub gamma lookup table 310, a second sub gamma lookup table 320, and an (N)th gamma lookup table 330.

Each of the first through (N)th sub gamma lookup tables 310, 320, and 330 stores luminance data L1 through L255 based on the gamma value. For example, the input gamma processing unit 300 may store five sub gamma lookup tables having different gamma values. The first sub gamma lookup table 310 may have a 2.2 gamma value, the second sub gamma lookup table 320 may have a 2.4 gamma value, and the third sub gamma lookup table may have a 2.6 gamma value. The fourth sub gamma lookup table may have a 2.8 gamma value and the fifth sub gamma lookup table 330 may have a 3.0 gamma value.

The multiplexer 340 may select one of the sub gamma lookup tables 310, 320, and 330 based on the gamma weight GW, and may output the selected sub gamma lookup table as the variable gamma lookup table 350. The gamma weight GW is a value that controls a degree of compensation for compensating gamma distortion of the display panel that has the pentile-shape structure. The gamma weight GW may be determined, for example, based on one or more properties of the display panel.

For example, the gamma weight GW may be determined based on a loading effect, because a gamma curve may be distorted by the loading effect. In one example embodiment, the gamma weight GW may increase when the gamma value of the gamma curve increases because of the loading effect and decrease when the gamma value of the gamma curve increases because of the loading effect.

The gamma weight GW may have values that lie in a predetermined range, e.g., higher than 0 and lower than 1. The multiplexer 340 may select the first sub gamma lookup table 310 and may output the first sub gamma lookup table 310 as the variable gamma lookup table 350 when the gamma weight GW is 0. Further, the multiplexer 340 may select the second sub gamma lookup table 320 and output the second sub gamma lookup table 320 as the variable gamma lookup table 350 when the gamma weight GW is 0.2. The input gamma processing unit 300 may generate the first image data 1ST ID, for example, by linearizing the input image data INPUT ID based on the variable gamma lookup table 350 and may output the first image data 1ST ID.

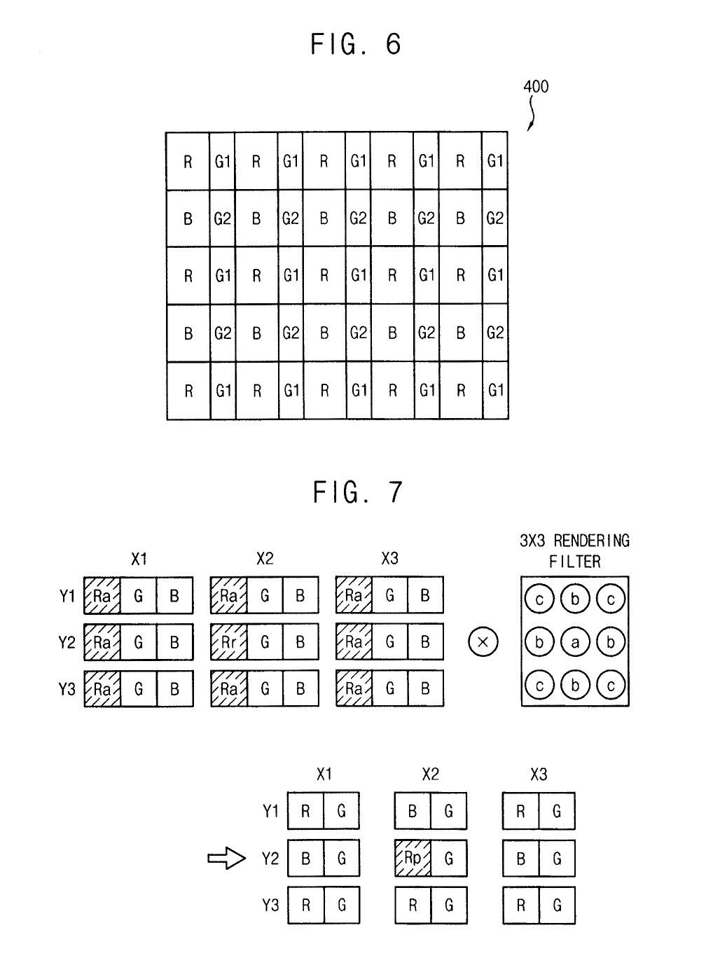

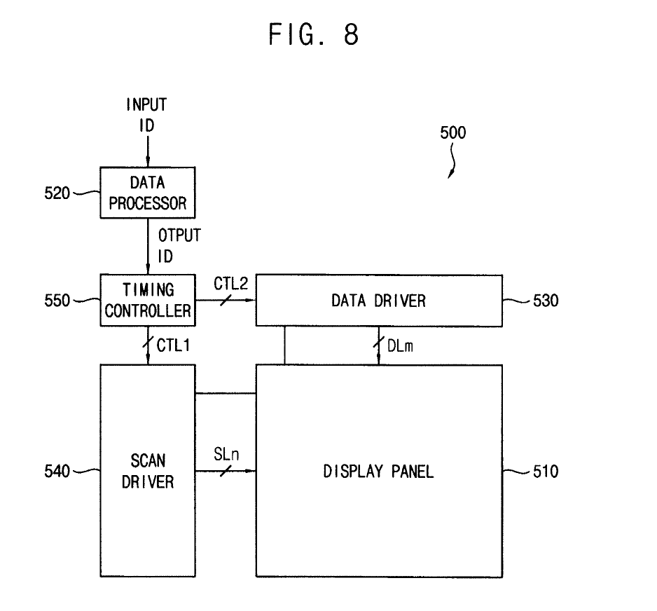

FIGS. 6 and 7 illustrates example operations of a rendering unit in the data processing device 100 of FIG. 1. Referring to FIGS. 6 and 7, a display panel the data processing device 100 with a pentile-shape structure has a pixel layout in which red color sub pixels R and blue color sub pixels B are alternately arranged in the same row and first green color sub pixels G1 and second green color sub pixels G2 are arranged adjacent to the red color sub pixels R and the blue color sub pixels B.

Input image data (e.g., from an external system) may be data for displaying an image on a display panel having a stripe-shape structure with a predetermined pixel layout. The predetermined pixel layout may include, for example, a red color sub pixel, a green color sub pixel and a blue color sub pixel that are sequentially arranged. The input image data may include red color grayscale data provided to the red color sub pixel, green color grayscale data provided to the green color sub pixel, and blue color grayscale data provided to the blue sub pixel.

The input image data may be converted to be applied to the display panel having a pentile-shape structure, in which the pixel layout includes a red sub color pixel R, a first green color sub pixel G1, a blue color sub pixel B, and a second green color sub pixel G2. For example, a rendering unit may render the first image data (that is linearized in an input gamma processing unit) using a rendering filter based on the pixel layout of the display panel 400 having the pentile-shape structure.

The rendering unit may store partial data of the first column of the first image data in a first filter buffer. The rendering unit may store partial data of the second column of the first image data in a second filter buffer. The rendering unit may store partial data of the third column of the first image data in a third filter buffer. The first image data, and/or the partial data of the first, second, and third columns, may have a size suitable for rendering through a rendering filter, e.g., a 3×3 rendering filter.

The rendering filter may render the first image data, corresponding to three columns and three rows stored in the first filter buffer, the second filter buffer, and the third filter buffer, based on applying a scale coefficient. The rendering filter may designate the scale coefficients a, b, and c to nine regions as described in FIG. 7.

Reference red color data Rr and neighboring eight red color data Ra, in a pixel of (X2, Y2) coordinates, pass through the rendering filter to be rendered into red color sub pixel data Rp corresponding to the red color sub pixel in the display panel having the pentile-shape structure. The reference red color data Rr and neighboring eight red color data Ra are respectively multiplied by scale coefficients corresponding thereto, and the sum of the multiplication results is calculated as a rendering value of the reference red color data Rr, e.g., the red color sub pixel data Rp. The blue color data may also be rendered into blue color sub pixel data in the display panel having the pentile-shape structure. The green color data may also be rendered into green color sub pixel data in the display panel having the pentile-shape structure. In another embodiment, the rendering unit may render the first image data using another type of filter, e.g., a 3×1 rendering filter.

FIG. 8 illustrates an embodiment of a display device 500 which includes a display panel 510, a data processor 520, a data driver 530, a scan driver 540, and a timing controller 550. The data processor 520 may correspond, for example, to the data processing device 100 in FIG. 1.

The display panel 510 may have a pentile-shape structure having a pixel layout which includes a red color sub pixel, a first green color sub pixel, a blue color sub pixel, and a second green color sub pixel. A plurality of data lines and a plurality of scan lines are displayed on the display panel 510. A plurality of pixels may be at respective intersection regions of the data lines and the scan lines.

The data processor 520 may include a variable gamma lookup table that is changed based on a predetermined gamma weight. The data processor 520 generates output image data OUTPUT ID by linearizing input image data INPUT ID based on the variable gamma lookup table, and by rendering the linearized input image data INPUT ID based on the pixel layout in which the red color sub pixel, the first green color sub pixel, the blue color sub pixel, and the second green color sub pixel are arranged.

For example, the data processor 520 may include an input gamma processing unit, a rendering unit, and an output gamma processing unit. The input gamma processing unit may generate a first image data by linearizing the input image data INPUT ID based on the variable gamma lookup table that is changed based the gamma weight. The variable gamma lookup table may store a variable luminance data that linearize the input image data INPUT ID. The variable gamma lookup table may be changed based on the predetermined gamma weight. The gamma weight is a value that controls a degree of a compensation to compensate for a gamma distortion of the display panel having the pentile-shape structure. The gamma weight may be determined, for example, based on one or more properties of the display panel. For example, the gamma weight may be determined based on a loading effect, because a gamma curve may be distorted by the loading effect. The gamma weight has values in a predetermined range, e.g., higher than 0 and lower than 1.

In one example embodiment, the input gamma processing unit includes a reference gamma lookup table and a compensation gamma lookup table. The compensation gamma lookup table stores compensation luminance data, which, for example, corresponds to a difference between reference luminance data corresponding to a reference gamma value and maximum luminance data corresponding to a predetermined maximum compensation gamma value. For example, the reference gamma value is 2.2 and the maximum compensation gamma value is 3.0. The variable gamma lookup table may store the variable luminance that is generated by adding a multiplication value of the compensation luminance data by the gamma weight to the reference luminance data.

In another example embodiment, the input gamma processing unit may include a plurality of sub gamma lookup tables having different gamma values. For example, the input gamma processing unit may includes sub gamma lookup tables that have one or more gamma values higher than a reference gamma value and lower than a maximum compensation gamma value. The input gamma processing unit may select one of the sub gamma lookup tables as the variable gamma lookup table based on the gamma weight.

The input gamma processing unit may generate the first image data by linearizing the input image data based on the variable gamma lookup table. The rendering unit may render the linearized first image data based on the pixel layout of the display panel 510 having the pentile-shape structure using the rendering filter. For example, the rendering unit may store partial data of the first image data, which has a size suitable for rendering through the 3×3 rendering filter, in a buffer and may render the first image data by applying a scale coefficient designated to regions. The rendering unit may also render the first image data using a 3×1 filter.

The output gamma processing unit generates output image data by non-linearizing the second image data based on an output gamma lookup table calculated using a reverse gamma function of the variable gamma lookup table. The output gamma lookup table, that is calculated by the reverse gamma function of the variable gamma lookup table, may be changed based on the gamma weight because the variable gamma lookup table is changed based on the gamma weight. The output gamma lookup table may store grayscale data that is calculated by the reverse gamma function of the variable gamma lookup table.

The output gamma processing unit may generate the output image data, that includes output grayscale data, by non-linearizing the second image data, that includes the variable luminance data, based on the output gamma lookup table. In another embodiment, the data processor 520 may further include an edge processing unit that processes an edge data and a dithering unit that performs a dithering function. The data processor 520 may, for example, be coupled to or included in the timing controller 550.

The scan driver 540 provides a scan signal to the pixels via the scan lines SLn. The data driver 530 provides data signals to the pixels via the data lines DLm according to the scan signal. The timing controller 550 may generate a plurality of control signals CTL1 and CTL2 to control the data driver 530 and the scan driver 540.

As described above, the display panel 500 may include the data processor 520 to compensate a distortion of the gamma of the display panel 510 having the pentile-shape structure. The data processor 520 may generate the first image data by linearizing the input image data based on the variable gamma lookup table that is changed based on the gamma weight, may generate the second image data by rendering the first image data, and may generate the output image data by non-linearizing the second image data based on the output gamma lookup table. The gamma weight is a value that controls a degree of compensation for compensating gamma distortion of the display panel 510 of the pentile-shape structure. The gamma weight may be determined, for example, by one or more properties of the display panel 510. The data processor 520 compensates gamma distortion in the display panel 510 having the pentile-shape structure by including the variable gamma lookup table having a gamma value which changes based on gamma weight. Thus, image quality of the display panel 510 may be improved.

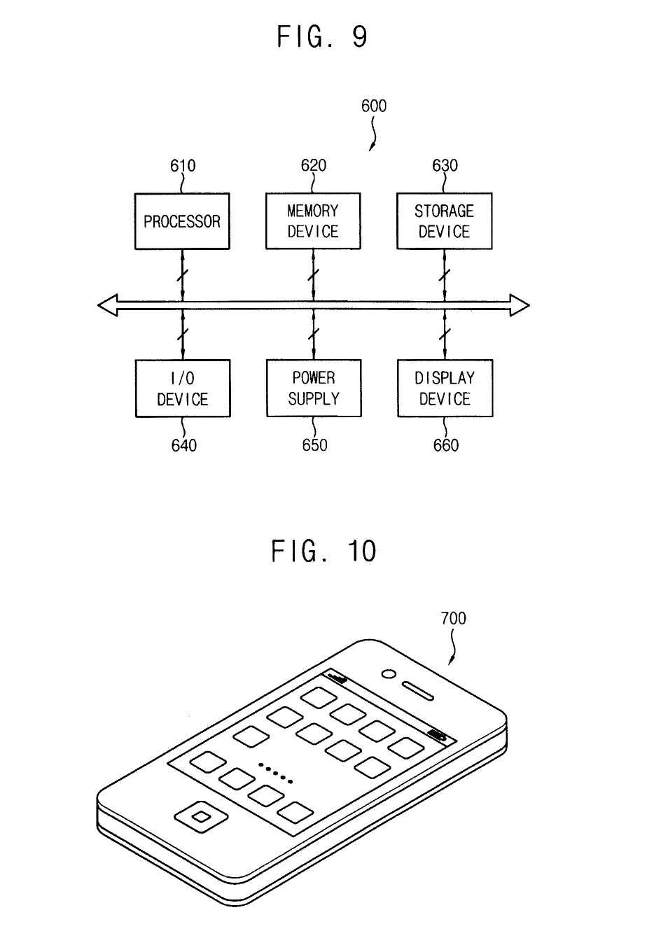

FIG. 9 illustrates an embodiment of an electronic device 600, which, for example, includes the display device 500 in FIG. 8. FIG. 10 illustrates an embodiment where the electronic device 600 in FIG. 9 is a smart phone 700.

Referring to FIGS. 9 and 10, an electronic device 600 includes a processor 610, a memory device 620, a storage device 630, an input/output (I/O) device 640, a power supply 650, and a display device 660. The display device 660 may correspond to the display device 500 of FIG. 8. In addition, the electronic device 600 may include a plurality of ports for communicating a video card, a sound card, a memory card, a universal serial bus (USB) device, other electronic device, etc. In another embodiment, the electronic device 600 may be an electronic device different from a smart phone.

The processor 610 may perform various computing functions. The processor 610 may be a microprocessor, a central processing unit (CPU), etc. The processor 610 may be coupled to other components via an address bus, a control bus, a data bus, etc. Further, the processor 610 may be coupled to an extended bus such as peripheral component interconnect (PCI) bus. The memory device 620 may store data for operations of the electronic device 200.

For example, the memory device 620 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 630 may be a solid state drive (SSD) device, a hard disk drive (HDD) device, a CD-ROM device, etc.

The I/O device 640 may be an input device such as a keyboard, a keypad, a touchpad, a touch-screen, a mouse, etc, and an output device such as a printer, a speaker, etc. In one example embodiment, the display device 660 may be in the I/O device 640. The power supply 650 provides power for operations of the electronic device 600. The display device 660 may communicate with other components via the buses or other communication links.

As described above, the display device 660 may include a display panel, a data processor, a data driver, a scan driver, and a timing controller. The display panel may have a pentile-shape structure having a pixel layout which includes a red color sub pixel, a first green color sub pixel, a blue color sub pixel, and a second green color sub pixel.

The data processor may include a variable gamma lookup table that is changed based on a predetermined gamma weight. The data processor may generate output image data by linearizing input image data based on the variable gamma lookup table and by rendering the linearized input image data based on the pixel layout of which the red color sub pixel, the first green color sub pixel, the blue color sub pixel, and the second green color sub pixel are arranged.

For example, the data processor may include an input gamma processing unit, a rendering unit, and an output gamma processing unit. The input gamma processing unit may generate a first image data by linearizing the input image data based on the variable gamma lookup table that is changed by the gamma weight. The variable gamma lookup table may store a variable luminance data that linearize the input image data. The variable gamma lookup table may be changed based on the predetermined gamma weight. The gamma weight is a value that controls a degree of compensation to compensate for gamma distortion of the display panel having the pentile-shape structure.

In one example embodiment, the input gamma processing unit may include a reference gamma lookup table and a compensation gamma lookup table. The compensation gamma lookup table may store compensation luminance data which corresponds to a difference between the reference luminance data corresponding to a reference gamma value and maximum luminance data corresponding to a predetermined maximum compensation gamma value. The variable gamma lookup table may store the variable luminance data that is generated by adding a multiplication value of the compensation luminance data by the gamma weight to the reference luminance data.

In one example embodiment, the input gamma processing unit includes a plurality of sub gamma lookup tables having different gamma values. The input gamma processing unit may select one of the sub gamma lookup tables as the variable gamma lookup table based on the gamma weight. The input gamma processing unit may generate the first image data by linearizing the input image data based on the variable gamma lookup table. The rendering unit may render the linearized first image data based on the pixel layout of the display panel having the pentile-shape structure by using the rendering filter.

The output gamma processing unit may generate the output image data by non-linearizing the second image data based on an output gamma lookup table that is calculated using a reverse gamma function of the variable gamma lookup table. The output gamma lookup table calculated by the reverse gamma function of the variable gamma lookup table may be changed based on the gamma weight, because the variable gamma lookup table is changed based on the gamma weight. The output gamma processing unit may generate the output image data that includes the output grayscale data by non-linearizing the second image data that includes the variable luminance data based on the output gamma lookup table.

The data processor may further include an edge processing unit that processes an edge data and a dithering unit that performs a dithering function. The scan driver provides a scan signal to the pixels via the scan lines. The data driver provides a data signal, that corresponds to the output image data provided to from the data processor, to the pixels via the data lines according to the scan signal. The timing controller may generate a plurality of control signals to control the data driver and the scan driver.

As described above, the electronic device 600 may include a display device 660 having the data processor. The data processor may generate the first image data by linearizing the input image data based on the variable gamma lookup table that is changed based on the gamma weight, may generate the second image data by rendering the first image data, and may generate the output image data by non-linearizing the second image data based on the output gamma lookup table. The gamma weight is a value that controls a degree of compensation for compensating gamma distortion of the display panel having the pentile-shape structure. The gamma weight may be determined by at least one property of the display panel.

The data processor compensates the gamma distortion in the display panel having the pentile-shape structure by including the variable gamma lookup table having one or more gamma values changed based on the gamma weight. Thus, image quality of the display panel may be improved.

The aforementioned embodiments may be applied to a display device and an electronic device having the display device. In addition to a smart phone, examples of the electronic device include a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

The drivers, processors, controllers, or other computing features of the aforementioned embodiments may be implemented in logic which, for example, may include hardware, software, or both. When implemented at least partially in hardware, the drivers, processors, controllers, or other computing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the drivers, processors, controllers, or other computing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

By way of summation and review, input image data may be converted to output data for display. However, a gamma curve of the display panel may be distorted when the input image data is converted to the output image data. In accordance with one or more of the aforementioned embodiments, a data processing device reduces or prevents gamma distortion of a display panel having a pentile-shape structure by linearizing input image data using a variable gamma lookup table changed based on a gamma weight.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A data processing device, comprising:
an input gamma processor to generate first image data, the input gamma processor to linearize input image data based on a variable gamma lookup table, the variable gamma lookup table to change based on a predetermined gamma weight;
a renderer to render the first image data to generate second image data; and
an output gamma processor to generate output image data based on non-linearizing the second image data based on an output gamma lookup table, the output gamma lookup table to be calculated based on a reverse gamma function of the variable gamma lookup table.

2. The data processing device as claimed in claim 1, wherein the input gamma processor includes:
a reference gamma lookup table to store reference luminance data according to a predetermined reference gamma value; and
a compensation gamma lookup table to store compensation luminance data to be used to compensate the reference luminance data.

3. The data processing device as claimed in claim 2, wherein:
the compensation gamma lookup table is to store compensation luminance data, and
the compensation luminance data is based on a difference between the reference luminance data corresponding to the reference gamma value and maximum luminance data corresponding to a predetermined maximum compensation gamma value.

4. The data processing device as claimed in claim 2, wherein the variable gamma lookup table is to store variable luminance data generated based on adding a multiplication value of the compensation luminance data and the gamma weight to the reference luminance data.

5. The data processing device as claimed in claim 1, wherein the input gamma processor includes a plurality of sub gamma lookup tables having different gamma values.

6. The data processing device as claimed in claim 5, wherein the input gamma processor is to select one of the sub gamma lookup tables as the variable gamma lookup table based on the gamma weight.

7. The data processing device as claimed in claim 1, wherein:
the data processor is in or coupled to a display device having a pentile-shape structure, and
the pentile-shape structure has a pixel layout which includes a red color sub pixel, a first green color sub pixel, a blue color sub pixel, and a second green color sub pixel.

8. The data processing device as claimed in claim 7, wherein the renderer is to render the first image data based on the pixel layout using a rendering filter.

9. The data processing device as claimed in claim 1, wherein the output gamma lookup table is to store grayscale data calculated based on the reverse gamma function of the variable gamma lookup table.

10. A display device, comprising:
a display panel having a pentile-shape structure, the pentile-shape structuring having a pixel layout which includes a red color sub pixel, a first green color sub pixel, a blue color sub pixel, and a second green color sub pixel;
a variable gamma lookup table to be changed based on a predetermined gamma weight;
a data processor to generate output image data, the data processor to linearize input image data according to the variable gamma lookup table and to render the linearized input image data according to the pixel layout;
a data driver to provide a data signal to the display panel, the data signal corresponding to the output image data;
a scan driver to provide a scan signal to the display panel; and
a timing controller to generate control signals to control the data driver and the scan driver.

11. The display device as claimed in claim 10, wherein the data processor includes:
an input gamma processor to generate first image data, the input gamma processor to linearize the input image data based on the variable gamma lookup table, the variable gamma lookup table to change based on the gamma weight;
a renderer to render the first image data to generate second image data; and
an output gamma processor to generate image data, the output gamma processor to non-linearize the second image data based on an output gamma lookup table, the output gamma lookup table to be calculated based on a reverse gamma function of the variable gamma lookup table.

12. The display device as claimed in claim 11, wherein the input gamma processor includes:
a reference gamma lookup table to store reference luminance data according to a predetermined reference gamma value; and
a compensation gamma lookup table to store compensation luminance data that compensates the reference luminance data.

13. The display device as claimed in claim 12, wherein:
the compensation gamma lookup table is to store compensation luminance data, and
the compensation luminance data based on a difference between the reference luminance data corresponding to the reference gamma value and a maximum luminance data corresponding to a predetermined maximum compensation gamma value.

14. The display device as claimed in claim 12, wherein the variable gamma lookup table is to store variable luminance data, the variable luminance data to be generated based on adding a multiplication value of the compensation luminance data and the gamma weight to the reference luminance data.

15. The display device as claimed in claim 11, wherein the input gamma processor includes a plurality of sub gamma lookup tables having different gamma values.

16. The display device as claimed in claim 15, wherein the input gamma processor is to select one of the sub gamma lookup tables as the variable gamma lookup table based on the gamma weight.

17. The display device as claimed in claim 11, wherein the renderer is to render the first image data based on the pixel layout using a rendering filter.

18. The display device as claimed in claim 11, wherein the output gamma lookup table is to store grayscale data calculated based on the reverse gamma function of the variable gamma lookup table.

19. The display device as claimed in claim 10, wherein the timing controller is coupled to the data processor.

20. The display device as claimed in claim 10, wherein the timing controller includes the data processor.
